(19) United States
(12) Patent Application Publication
(10) Pub. No.: US 2009/0037690 A1
(43) Pub. Date: Feb. 5, 2009

(54) Dynamic Pointer Disambiguation

(75) Inventors: ALEXANDER BUSCK, GOTEBORG (SE); MIKAEL ENGBOM, GOTEBORG (SE); PER STENSTROM, TORSLANDA (SE); FREDRIK WARG, BORAS (SE)

Correspondence Address: FISH & RICHARDSON P.C., PO BOX 1022, MINNEAPOLIS, MN, 55440-1022, US

(73) Assignee: Nema Labs AB

(21) Appl. No.: 12/180,959

(22) Filed: Jul. 28, 2008

Related U.S. Application Data
(60) Provisional application No. 60/953,695, filed on Aug. 3, 2007.

(51) Int. Cl. G06F 12/02

(52) U.S. Cl. 711/221; 711/E12.014

(57) ABSTRACT

Dynamic pointer analysis techniques are able to produce faster pointer dependency test code and analyze more complex code in high-level languages such as in the programming languages C and C++ (not excluding other languages), as compared to known techniques.

### CLAIM OF PRIORITY

This application claims the benefit of priority under 35 U.S.C. § 119(e) to U.S. provisional application Ser. No. 60/953,695, filed Aug. 3, 2007, which is incorporated herein by reference in its entirety.

### TECHNICAL FIELD

This application pertains to the field of multiprocessor computer systems and how to utilize the plurality of processors in such a computer system to speedup a program designed for a single processor by exploiting thread-level parallelism.

### BACKGROUND

A multiprocessor computer comprises a plurality of processors and a memory. The memory contains a plurality of memory locations. A processor may access a location in the memory with a read or a write instruction using a unique address for that location. The read and write instructions may be the ones ordinarily used in microprocessors. These instructions may also be implemented by software routines to emulate a global memory comprising locations that may be accessed by the plurality of processors.

Consider a program partitioned into a plurality of program segments enumerated P₁, P₂, . . . , P_{N} assuming N program segments. The program segments must execute one after each other in the enumeration order for the program to execute correctly on a single processor. This order is said to respect “sequential semantics.” In order to shorten the execution time of the program on a multiprocessor computer, some of the program segments are executed in parallel on a plurality of processors; that is, they do not execute one after the other according to the enumeration order, but substantially at the same time.

Any two program segments I and J in enumeration order, where I<J, may execute in parallel without violating sequential semantics if program segments I and J do not access the same memory locations. It may be further possible to execute them in parallel when it may be established that program segment I will not write to a location after program segment J has read from that same location.

Known compilers may sometimes partition a program into program segments using the described partitioning method and may attempt to establish which program segments may execute in parallel, respecting sequential semantics, by taking note of whether they access the same memory location according to the conditions established above. Due to limitations of known analysis methods or because the accessed locations are unknown at compile-time, few programs may be partitioned using known compiler methods to allow for parallel execution of program segments on a plurality of processors in a multiprocessor computer. Specifically, if the program refers to memory locations using pointers (as used in programming languages such as C), the compiler often may not be able to ascertain whether two program segments that use different pointers can execute in parallel. This is because it may not be possible to establish at compile time whether the pointers will point to the same memory locations when the program is executed.

In one family of techniques, known as dynamic pointer disambiguation techniques, the goal is to establish whether or not two or more pointers can access the same memory location during run-time by inserting dependency test code into the program. If it can be established that two pointers never access the same location, it is possible to allow more program segments to execute in parallel. Dynamic pointer disambiguation techniques may thereby increase thread-level parallelism.

Two important criteria comprise how successful a given dynamic pointer disambiguation technique will be at speeding up the execution time of an application by increasing thread-level parallelism: (1) a technique that can produce fast dependency test code (which typically results in reduced overhead latency) will be more successful at speeding up the execution time of applications than a technique that produces slower dependency test code, and (2) a technique that is able to analyze more complex program constructs can potentially create additional opportunities to implement thread-level parallelism, and thereby reduce the execution time of the application.

### SUMMARY

Herein is presented dynamic pointer disambiguation techniques that may produce faster pointer dependency test code and analyze more complex code in high-level languages.

In one aspect, a computer-implemented method is provided for performing dynamic pointer disambiguation, comprising: locating one or more indexing expressions within a code segment to be parallelized; generating code that establishes at run-time a first memory allocation area for a first pointer in the code segment to be parallelized by calculating a lower bound and an upper bound of the first memory allocation area, wherein the lower and upper bounds of the first memory allocation area are defined by at least one of the one or more indexing expressions; generating code that establishes at run-time a second memory allocation area for a second pointer in the code segment to be parallelized by calculating a lower bound and an upper bound of the second memory allocation area, wherein the lower and upper bounds of the second memory allocation area are defined by at least one of the one or more indexing expressions; and generating dependency test code that compares the lower bound and the upper bound of the first memory allocation area against the lower bound and the upper bound of the second memory allocation area to determine whether an overlap exists, wherein the first pointer and the second pointer both appear within the code segment to be parallelized, and wherein at least one of the first pointer and the second pointer has write access.

In another aspect, a computer-implemented method is provided for performing dynamic pointer disambiguation wherein no overlap exists, further comprising executing a parallelized version of the code segment.

In another aspect, a computer-implemented method is provided for performing dynamic pointer disambiguation wherein an overlap does exist, further comprising executing a sequential version of the code segment.

In one aspect, a computer-implemented method is provided for performing dynamic pointer disambiguation, comprising: analyzing one or more code segments preceding a code segment to be parallelized, wherein a code segment comprises one or more statements; inserting a test code segment, wherein the test code segment is inserted after a statement, and wherein the test code segment operates to update a memory allocation table, the memory allocation table comprising one or more entries, wherein each of the one or more entries comprises a lower bound and an upper bound for a block of memory; generating code that establishes at run-time a memory allocation area for a pointer in the code segment to be parallelized, wherein establishing a memory allocation area for a pointer comprises comparing a lower bound and an upper bound of a block of memory that can be accessed by the pointer against the memory allocation table; and generating dependency test code that compares a first lower bound and a first upper bound of a first memory allocation area for a first pointer against a second lower bound and a second upper bound of a second memory allocation area for a second pointer to determine whether an overlap exists, wherein at least one of either the first pointer or the second pointer has write access.

In another aspect, a computer-implemented method is provided for performing dynamic pointer disambiguation wherein analyzing comprises detecting a statement that allocates a block of memory.

In another aspect, a computer-implemented method is provided for performing dynamic pointer disambiguation analyzing comprises detecting a statement that deallocates a block of memory.

In another aspect, a computer-implemented method is provided for performing dynamic pointer disambiguation wherein the test code segment is inserted after the statement that allocates a block of memory, and wherein the test code segment operates to add an entry to the memory allocation table, wherein the entry corresponds to a lower bound and an upper bound of the block of memory.

In another aspect, a computer-implemented method is provided for performing dynamic pointer disambiguation wherein the test code segment is inserted after the statement that deallocates a block of memory, and wherein the inserted test code segment operates to locate and remove an entry in the memory allocation table, wherein the entry corresponds to a lower bound and an upper bound of the block of memory.

In one aspect, a computer program product is provided, wherein the product is stored on a tangible computer readable medium, the product comprising instructions operable to cause a computer system to perform a method comprising: locating one or more indexing expressions within a code segment to be parallelized; generating code that establishes at run-time a first memory allocation area for a first pointer in the code segment to be parallelized by calculating a lower bound and an upper bound of the first memory allocation area, wherein the lower and upper bounds of the first memory allocation area are defined by at least one of the one or more indexing expressions; generating code that establishes at run-time a second memory allocation area for a second pointer in the code segment to be parallelized by calculating a lower bound and an upper bound of the second memory allocation area, wherein the lower and upper bounds of the second memory allocation area are defined by at least one of the one or more indexing expressions; and generating dependency test code that compares the lower bound and the upper bound of the first memory allocation area against the lower bound and the upper bound of the second memory allocation area to determine whether an overlap exists, wherein the first pointer and the second pointer both appear within the code segment to be parallelized, and wherein at least one of the first pointer and the second pointer has write access.

In another aspect, a computer program product is provided, wherein no overlap exists, further comprising executing a parallelized version of the code segment.

In another aspect, a computer program product is provided, wherein an overlap does exist, further comprising executing a sequential version of the code segment.

In one aspect, a computer program product is provided, wherein the product is stored on a tangible computer readable medium, the product comprising instructions operable to cause a computer system to perform a method comprising: analyzing one or more code segments preceding a code segment to be parallelized, wherein a code segment comprises one or more statements; inserting a test code segment, wherein the test code segment is inserted after a statement, and wherein the test code segment operates to update a memory allocation table, the memory allocation table comprising one or more entries, wherein each of the one or more entries comprises a lower bound and an upper bound for a block of memory; generating code that establishes at run-time a memory allocation area for a pointer in the code segment to be parallelized, wherein establishing a memory allocation area for a pointer comprises comparing a lower bound and an upper bound of a block of memory that can be accessed by the pointer against the memory allocation table; and generating dependency test code that compares a first lower bound and a first upper bound of a first memory allocation area for a first pointer against a second lower bound and a second upper bound of a second memory allocation area for a second pointer to determine whether an overlap exists, wherein at least one of either the first pointer or the second pointer has write access.

In another aspect, a computer program product is provided, wherein analyzing comprises detecting a statement that allocates a block of memory.

In another aspect, a computer program product is provided, wherein analyzing comprises detecting a statement that deallocates a block of memory.

In another aspect, a computer program product is provided, wherein the test code segment is inserted after the statement that allocates a block of memory, and wherein the test code segment operates to add an entry to the memory allocation table, wherein the entry corresponds to a lower bound and an upper bound of the block of memory.

In another aspect, a computer program product is provided, wherein the test code segment is inserted after the statement that deallocates a block of memory, and wherein the inserted test code segment operates to locate and remove an entry in the memory allocation table, wherein the entry corresponds to a lower bound and an upper bound of the block of memory.

In one aspect, a system is provided, comprising: a machine-readable storage device including a computer program product; a display device; and one or more processors capable of interacting with the display device and the machine-readable storage device, and operable to execute the computer program product to perform operations comprising: locating one or more indexing expressions within a code segment to be parallelized; generating code that establishes at run-time a first memory allocation area for a first pointer in the code segment to be parallelized by calculating a lower bound and an upper bound of the first memory allocation area, wherein the lower and upper bounds of the first memory allocation area are defined by at least one of the one or more indexing expressions; generating code that establishes at run-time a second memory allocation area for a second pointer in the code segment to be parallelized by calculating a lower bound and an upper bound of the second memory allocation area, wherein the lower and upper bounds of the second memory allocation area are defined by at least one of the one or more indexing expressions; and generating dependency test code that compares the lower bound and the upper bound of the first memory allocation area against the lower bound and the upper bound of the second memory allocation area to determine whether an overlap exists, wherein the first pointer and the second pointer both appear within the code segment to be parallelized, and wherein at least one of the first pointer and the second pointer has write access.

In another aspect, a system is provided, wherein no overlap exists, further comprising executing a parallelized version of the code segment.

In another aspect, a system is provided, wherein an overlap does exist, further comprising executing a sequential version of the code segment.

In one aspect, a system is provided, comprising: a machine-readable storage device including a computer program product; a display device; and one or more processors capable of interacting with the display device and the machine-readable storage device, and operable to execute the computer program product to perform operations comprising: analyzing one or more code segments preceding a code segment to be parallelized, wherein a code segment comprises one or more statements; inserting a test code segment, wherein the test code segment is inserted after a statement, and wherein the test code segment operates to update a memory allocation table, the memory allocation table comprising one or more entries, wherein each of the one or more entries comprises a lower bound and an upper bound for a block of memory; generating code that establishes at run-time a memory allocation area for a pointer in the code segment to be parallelized, wherein establishing a memory allocation area for a pointer comprises comparing a lower bound and an upper bound of a block of memory that can be accessed by the pointer against the memory allocation table; and generating dependency test code that compares a first lower bound and a first upper bound of a first memory allocation area for a first pointer against a second lower bound and a second upper bound of a second memory allocation area for a second pointer to determine whether an overlap exists, wherein at least one of either the first pointer or the second pointer has write access.

In another aspect, a system is provided, wherein analyzing comprises detecting a statement that allocates a block of memory.

In another aspect, a system is provided, wherein analyzing comprises detecting a statement that deallocates a block of memory.

In another aspect, a system is provided, wherein the test code segment is inserted after the statement that allocates a block of memory, and wherein the test code segment operates to add an entry to the memory allocation table, wherein the entry corresponds to a lower bound and an upper bound of the block of memory.

In another aspect, a system is provided, wherein the test code segment is inserted after the statement that deallocates a block of memory, and wherein the inserted test code segment operates to locate and remove an entry in the memory allocation table, wherein the entry corresponds to a lower bound and an upper bound of the block of memory.

The details of one or more embodiments are set forth in the accompanying drawings and the description below. Other features, objects, and advantages will be apparent from the description and drawings, and from the claims.

### BRIEF DESCRIPTION OF DRAWINGS

FIG. 1 is a set of exemplary code segments written in C.

FIG. 2 is an illustration of an exemplary multi-processor computer system.

FIG. 3 is a flow chart of a method for generating dependency test code.

FIG. 4 is a flow chart of a method for gathering information to select efficient dynamic disambiguation techniques.

FIG. 5 illustrates the PointsTo map structure used to implement the method illustrated in FIG. 3.

FIG. 6A is a flow chart of a first method for generating pointer bounds as inputs for the dependency test code.

FIG. 6B is an example and table structure for the method illustrated in FIG. 6A.

FIG. 6C is a set of exemplary code segments written in C for the method illustrated in FIG. 6A.

FIG. 7A is a flow chart of a second method for generating pointer bounds as inputs for the dependency test code.

FIG. 7B is an exemplary structure to be used with the method illustrated in FIG. 7A.

FIG. 8 is a flow chart of a method for generating dependency test code.

Like reference symbols in the various drawings indicate like elements.

### DETAILED DESCRIPTION

Dynamic pointer disambiguation techniques can produce faster dependency test code and analyze more complex code (e.g., using structures—i.e., struct in the programming language C—multi-dimensional pointers, and some control-flow dependent problems) in high-level languages such as in C and C++ (not excluding other languages), when compared to previously known techniques.

A method to generate dependency test code to determine if pointer accesses may overlap may comprise: (1) performing static analysis of code segments preceding the code to be parallelized in order to (a) reduce the amount of dependency test code that has to be executed and (b) gather information needed for the dependency test code; (2) using one of two disclosed techniques to determine the memory interval (i.e., lowest and highest memory location) that a pointer may access; and (3) generating dependency test code to make sure that memory intervals to which a first pointer may write do not overlap with other memory intervals to which a second pointer may read or write data. If the dependency test indicates no such overlap (i.e., potential dependency) exists, then a parallelized version of the code to be optimized is executed, otherwise the original sequential version is executed.

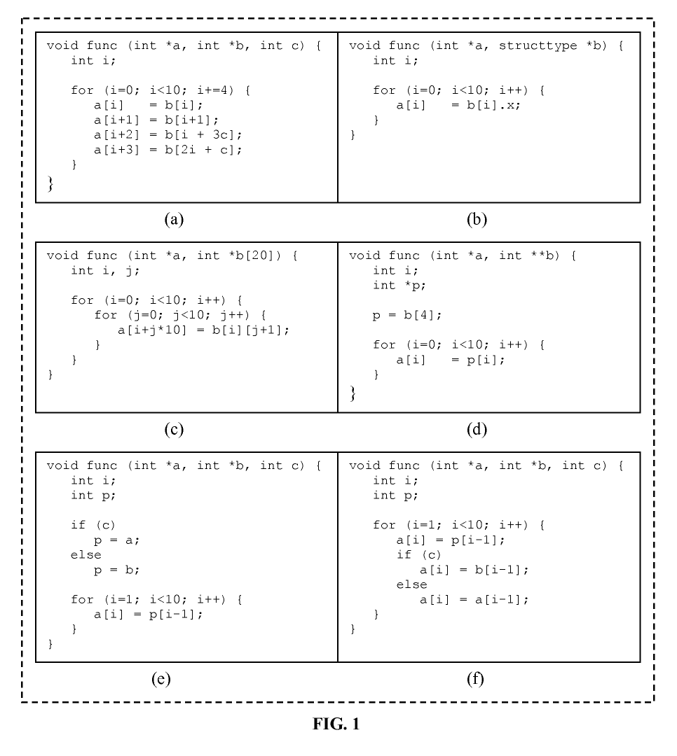

FIG. 1 presents a set of exemplary code segments written in C. When applied to the loop in FIG. 1(a), a first method to determine the memory interval comprises forming one group for array a and another for array b, advantageously followed by a single (rather than multiple) interval comparison. A second method to determine the memory interval also finds one memory access interval for each pointer, but the intervals are obtained in a different manner. Instead of computing the bounds, a list of known allocated memory areas (a memory area being a set of consecutive memory locations) are kept in a list. Before executing a parallelized loop dependency test code is inserted that does the following: pointers used within the loop are matched to the known areas, and then the identities of these areas are used to check if any two pointers work on the same memory area. This method may generate even faster dependency test code than the first method if the number of used memory areas is small.

A static pointer analysis method is described that provides enough information to create dependency test code for structures and multi-dimensional pointers, such as the pointers used in the examples in FIGS. 1(b-d). Control-flow-sensitive dependency test code may also be included in order to determine if a parallel or sequential version of the loop is to be executed.

### A. Basics of a Multi-processor Systems

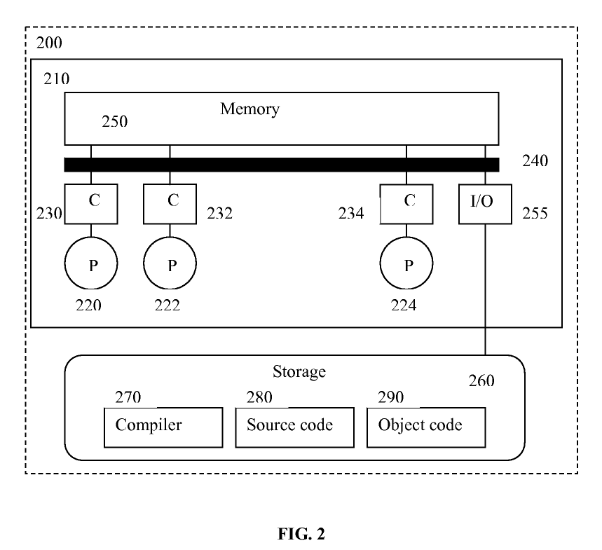

FIG. 2 illustrates one embodiment of a multi-processor computer system. According to FIG. 2, computer system 200 comprises a multiprocessor 210 and a storage component 260. Multiprocessor 210 comprises a plurality of processors 220, 222, and 224 connected to private caches 230, 232, and 234. This exemplary embodiment uses three processors, but any number of processors is possible, e.g., four or eight processors. Each cache may comprise several levels, e.g., two levels of cache. Further, any processor and its associated cache, e.g., processor 220 and cache 230 is connected to an interconnect 240 that makes it possible for a cache to send to memory 250, or to any other cache, a request for a block of memory, i.e., several contiguous locations. For example, cache 230 may send a request signal to cache 232.

Hence, in one embodiment, interconnect 240 may be a bus and in another embodiment, interconnect 240 may be a crossbar switch. Other embodiments may use other interconnect topologies. In yet another embodiment, memory 250 is implemented as another level of the memory hierarchy, e.g., a secondary or tertiary cache, which then interfaces to the memory.

Another embodiment may comprise a plurality of processors according to FIG. 2 where private caches are replaced by local memories that may be only accessed by the processor attached to that local memory. In such an embodiment, an exemplary read or write instruction by processor 220 may access local memory attached to 222 by invoking a software routine that sends a signal to processor 222. This signal may invoke a software routine to be executed by processor 222 that carries out the memory access in the local memory of processor 222 and possibly returns a value to processor 220 by sending a signal to processor 220 along with the value.

In some embodiments, cache coherence is maintained between 230, 232, and 234. One embodiment uses a write-invalidate cache coherence mechanism in which caches 230, 232, and 234 are kept consistent by invalidating a block of memory in one cache when a processor attached to another cache modifies this same block of memory by means of a write operation. In another embodiment, caches 230, 232, and 234 are kept consistent using a write-update cache coherence mechanism in which one block of memory is updated when a processor attached to another cache modifies that same block of memory. In one embodiment, the distribution protocol of invalidate and update requests may be one-to-all, so called snoopy cache protocols, and in another embodiment one-to-one, so called directory-based protocols.

Storage device 260 represents one or more devices used to store data, which may be connected to the multiprocessor via an I/O interface 255. The storage device may comprise magnetic disc storage mediums, flash memory drives, or any other storage medium accessible by the processors. The storage medium may store a compiler 270, source code 280 written in a high-level language, and object code 290. The compiler comprises instructions that can be executed, by e.g., processors 220, 222, and 224, thereby producing either object code or a new version of the source code from the original source code. In an alternative embodiment, the system may not be processor-based and the compiler's functionality can be implemented in hardware taking the form of for example an interpreter that translates the source code line-by-line to binary code executed on one or several processors. In one embodiment, the interpreter can be implemented by a program run on a processor and in another embodiment the interpreter can be implemented in hardware, for example controlled by microcode.

In the exemplary embodiment to be described in the following, compiler 270 creates run-time memory dependency test code used to create parallelized versions of the original source code.

### B. Parallelizing a Program Using Dynamic Pointer Disambiguation

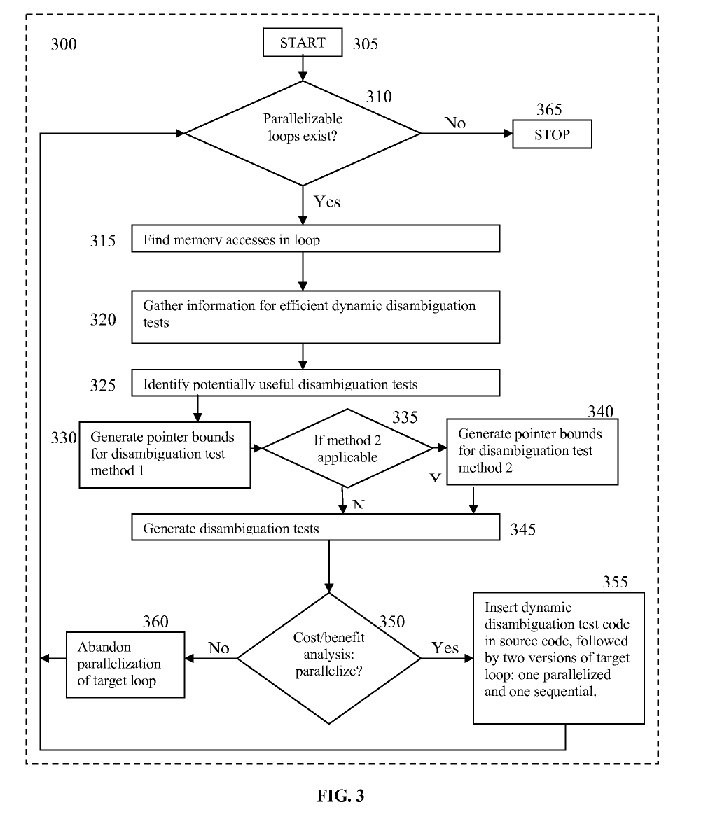

FIG. 3 illustrates the overall method for parallelizing a program with dynamic pointer disambiguation. At starting point 305, the system receives or generates a program or part of the program written in a high-level language such as C or C++, although other embodiments could use other high-level languages where pointer/array disambiguation is useful, for instance Java, C# or Fortran. In this program, code sequences which are suitable candidates for parallelization are identified. Identifying suitable sequences can be done in various ways, for instance by using a profiling tool to identify where most of the execution time is spent. These sequences are assumed to be loops, where iterations of the loop can be executed in parallel instead of sequentially. It is understood by someone skilled in the art that the disclosed method could be modified to parallelize program sequences other than loops.

The system works iteratively as long as loops that can be parallelized are identified (step 310). For each loop, all memory accesses (e.g., pointer and array accesses) are first identified (step 315). Then, the code preceding the loop (typically from the same program function) is analyzed in order to gather information used to improve the precision of the generated dependency test code (step 320). This process is described in Section C. The next step is selection of among a set of dynamic disambiguation techniques to determine the memory intervals (step 325). In this particular embodiment there are two such techniques. In other embodiments, there could be any number of techniques, for example four.

In this embodiment, two techniques are used to find the lower and upper bounds of memory addresses that a pointer may access (steps 330 and 340). These techniques can be used either separately or, in some situations, in combination. For example, in one embodiment, a first technique (step 330) is always used but a second technique (step 340) is only used if it applies. Therefore, there is a decision box (step 335) that decides whether the second technique should also be used. These techniques are described in Section D (first technique, step 330) and Section E (second technique, step 340). The information about the lower and upper bounds, together with the data gathered in the preceding steps are used to generate the final dependency test code (step 345). A cost/benefit analysis is performed on the generated dependency test code (step 350) and the loop to be parallelized; this analysis determines whether the cost (in execution time) for the dependency tests is likely to be offset by the gain in parallelism. If the cost/benefit analysis determines that the dependency tests are beneficial, the dependency tests are inserted in the program (355), and a parallelized version of the original loop is generated and inserted to run under the condition where the dependency tests, at run-time, are able to determine that the loop may be parallelized. If the cost/benefit analysis is negative, the parallelization effort is abandoned (360) and any generated dependency test code discarded.

There may be cases where the first technique is not able to establish the lower and upper bounds of the memory interval; in such cases, a second technique may be appropriate. Consider for example the following code

x =malloc(sizeof(interval_size));
y = z;
foo(x,y)
foo(x,y) {
for (i=1; i<N;i++)

*y++ =x[z[i]];

In this example, function foo uses two pointer variables x and y, and there is a potential overlap between the memory regions they access in the loop. The first technique can collect the information needed for a run-time test for the pointer variable y but may fail to do the same for pointer variable x because of the indexing function z[i]. The second technique, on the other hand may gather the additional information that x always accesses the memory region allocated with the function malloc and whose size is interval_size. This additional information can be used to generate a test that establishes whether x and y can overlap. Therefore, in one embodiment, only the first technique may be necessary and in other embodiments both techniques are required. Further, if it can be established that two pointer variables always read from memory and never write to it, dependency test code need not be generated to establish whether or not there is overlap between the memory regions they can access because no dependencies should arise. For example, if three pointer variables A, B, and C are used in a program, and only pointer variable A can write to memory, then one should test whether the memory region accessed by A overlaps with that of B and the memory region accessed by A overlaps with that of C, but one need not test whether the memory regions accessed by B and C overlap with each other.

### C. Gathering Information for Efficient Dynamic Disambiguation

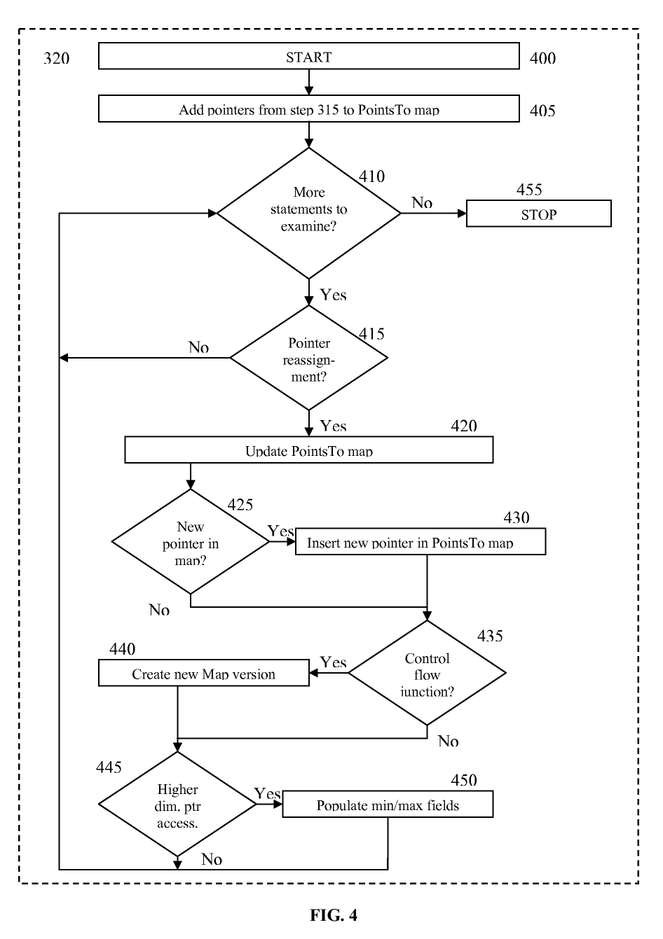

FIG. 4 is a flow chart for a method to identify the pointers that are dynamically disambiguated. This flow chart describes in detail box 320 in FIG. 3.

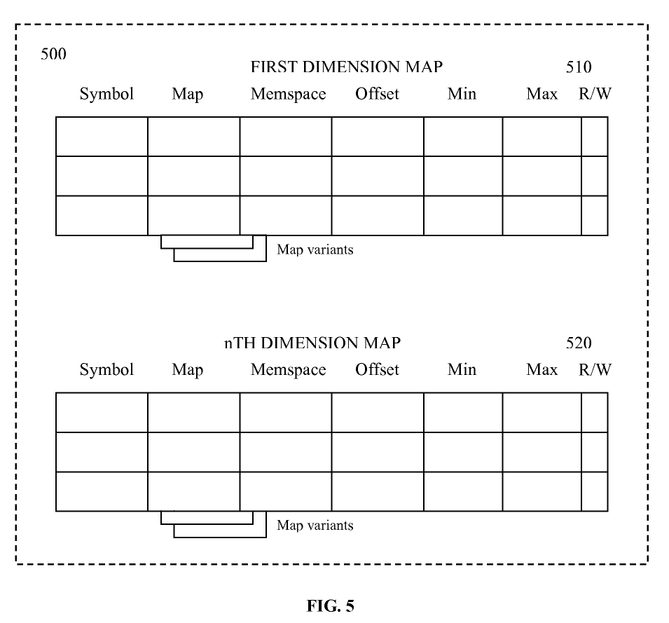

The input to this method is the information regarding memory accesses produced in step 315 in FIG. 3, i.e., a list of all pointers used in the loop to be parallelized. As a first action (step 405) said pointers are added to the list shown in FIG. 5: PointsTo maps 500. For the code example in FIG. 1d (below referred to simply as example 1d), pointers a and p would be inserted in the list. PointsTo maps 500 will then be updated as the function containing the loop to be parallelized is analyzed one program statement at a time.

For each pointer or array, the corresponding symbol is inserted in the Symbol field of the appropriate dimension PointsTo map in FIG. 5. For instance, for the pointer *a in example 1d, the symbol a is inserted in First Dimension Map 5 10. For a double pointer * *b, the symbol b would be inserted in the Second Dimension Map (e.g., 520).

The Map field tracks aliasing information, and is updated whenever a pointer is reassigned. Initially, the Map field is equal to the Symbol field. There may be more than one Map for each symbol (map variants). This will occur if program flow can not be determined statically; there will be a separate Map variant for each potential path through the program.

The Memspace field is a set that contains memory areas, wherein a memory area is a set of consecutive memory locations that the pointer may point to. If this information is not known, e.g., when pointers are passed as arguments to a function from code which can not be analyzed, the Memspace field is set to m. The set m denotes the entire set of available memory areas. The Memspace set is empty for uninitialized pointers, or it may comprise a symbol representing a known allocated memory area. In example 1d, the pointer a would get a Memspace set of m, while pointer p would have an uninitialized Memspace field. The Memspace set is used to avoid creating dynamic disambiguation tests for pointers which can be statically disambiguated by the compiler. If two pointers, after the analysis phase is completed, are not initialized or have known and separate Memspace sets, they cannot access the same memory location within the loop to be parallelized, and hence a dependency test is not needed.

The Offset field contains an offset value which is used for arithmetic calculations on pointers (i.e., not reassignments; if a pointer is reassigned the Map field is updated instead). The Min and Max fields contain a value or symbol for the lower and upper bounds on the size of lower dimensions for multi-dimension pointers. For instance, in the example in FIG. 1c, the pointer *b in the FIRST DIMENSION MAP will have 0 in the Min field and 9 in the Max field since the first dimension is an array of size 10. The R/W field is a bit which is set to one if there is a write access by the pointer within the loop to be parallelized, otherwise it is zero. These fields are further described below.

After the tables in the PointsTo maps 500 are initialized, each statement in the program from the starting point (typically from the first line in the current function, but could also be a larger piece of code, for instance from the first line of the entire application) to the end of the loop to be parallelized is examined (step 410).

If a pointer is reassigned (step 415), the new assignment for the symbol is recorded in the Map field (step 420), and the Memspace field for the pointer becomes a copy of the Memspace field of the symbol inserted in the Map field. If the Map field references a symbol that is not yet present in the PointsTo maps (step 425), a new entry is created for the new symbol in the appropriate dimension map (step 430). In example 1d, the statement p=b[4] reassigns pointer p. b[4] will be inserted in the Map field for symbol p, and Memspace for p will become a copy of Memspace for b. Since b is not already inserted in the PointsTo maps 500, it is now inserted. The Memspace for b is m (since there are no known boundaries to the space it may point at), and hence the new Memspace for p is also m. If the pointer is updated with pointer arithmetic, the Offset field is updated. If the reassignment of the pointer occurs in a control flow path which is an alternative to a previously explored path (step 435), a new Map variant is created (step 440). In the code example in FIG. 1e, there will be two variants for pointer p; one variant which maps p to a is valid if the if(c) statement evaluates to true, and one variant which maps p to b if it evaluates to false.

If the statement contains a higher-dimension pointer access (step 445), the Min and Max fields are populated with temporary values or symbols to denote that tests need to be generated for these accesses (step 450). For instance, if a double pointer **b is used, in one embodiment, tests may be generated for all the pointers in the first dimension array of pointers. During the analysis of the loop to be parallelized, the Min and Max values are updated with the lowest and highest indices used for the lower dimension in said loop to enable creation of tests for all the pointers in the lower-dimension array. If necessary, the first or second method to generate dynamic disambiguation tests described below are iteratively applied to all pointers in the lower-dimension array(s).

Finally, a pointer can be of a complex data type, such as a struct. If this is the case, the relevant item in the struct can be inserted in PointsTo maps 500 as its own symbol and treated in the same way as simple data types. In the code example in FIG. 1b, the access b[].x would be a unique symbol in PointsTo maps 500.

The information contained in PointsTo maps 500 when no more statements remain (step 455) is used for creation of the dynamic disambiguation tests.

### D. A First Technique to Generate Pointer Bounds

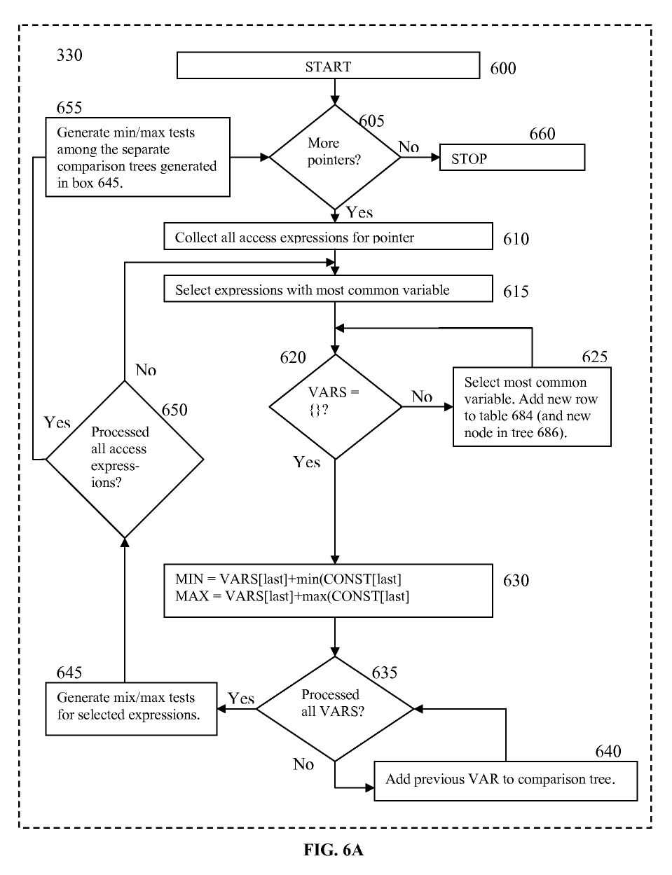

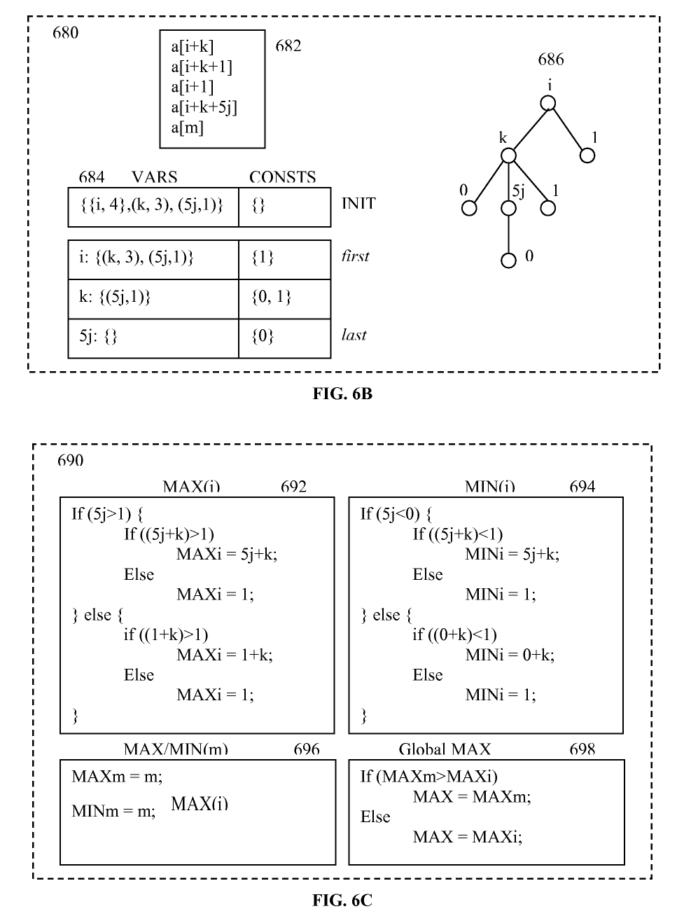

A first technique to generate pointer bounds is described in FIG. 6A. The flow chart in FIG. 6A describes in detail the technique referred to in box 330 of FIG. 3. Steps 315, 320, and 325 in FIG. 3 provide the inputs.

Code is created for computing the lower and upper pointer bounds on the memory interval that each pointer may access; these pointer bounds are later used when generating the dependency tests as described in Section E.

Lower and upper bounds are computed for all identified pointers. A check is performed (step 605) to determine if all of the pointers identified in step 315 have been processed. If not, the next pointer that has not yet been processed is selected, and all expressions used as an index to the selected pointer within the loop to be parallelized are collected into a list (step 610). FIG. 6B shows an example where five expressions used to index array a have been collected into exemplary list 682.

Next, the list 682 is converted to one or more tree representations. This is done by selecting index expressions in list 682 with common variables (step 615). In exemplary list 682, the variable i is common for all expressions but the last (a[m]). Therefore, i is the first variable selected (step 615). Information for the selected expressions is gathered in the INIT row of table 684 shown in FIG. 6B. For each index expression containing the main variable i, the frequency of other variables is recorded. In the example, the variable k occurs in three expressions and j in one expression.

One or several new rows are then added to table 684 by repeatedly selecting the variable with most remaining occurrences from the initially selected expressions. If there is at least one remaining variable in the VARS field of the currently last row in the table (step 620), the variable in the currently last row with most occurrences is selected (step 625). A new row is created in table 684, and optionally a new node in a corresponding tree 686 for this variable. The new row contains a new VARS field containing the remaining variables and a CONST field containing any constant terms attached to this combination of variables. In the example, when i is selected, there remain three expressions: one with k, one with j, and one with the constant 1. New rows are added to table 684 until the current row has an empty VARS set. When this happens, the current row in table 684 becomes the last row.

The following steps create run-time calculations and if-then tests used to find the local minimum (MIN) and maximum (MAX) values for the pointer access index for the selected expressions. This is done by traversing table 684 beginning at the last row.

Beginning at the last row, the initial values for MIN and MAX are set to the variable (VARS column in table 684) minus the smallest constant (CONST column) for MIN and the same variable plus the largest constant for MAX (step 630). In the example, the initial expressions would be MIN=5j+0 and MAX=5j+0 since 0 is the only CONST in the last row.

After the initial assignment, a tree of nested if-then statements is constructed by adding conditions from previous lines in table 684 (or by working upwards in tree 686). In the example, adding the line for variable k would result in the test if(5j>1) for MAX and if(5j<0) for MIN. The next iteration (steps 635 and 640) then adds another level of if-then tests for each outcome of the if-then test in the previously processed row, and so on until the first row is reached. When the first row has been processed, the set of if-then tests is completely generated (645).

FIG. 6C shows a set of exemplary code segments 690 written in C for the technique illustrated in the flow chart in FIG. 6A. In one embodiment, code in the C programming language for the example in list 682 is shown in segment 692 (for MAX) and segment 694 (for MIN). In other embodiments, the generated tests may differ. One skilled in the art can generate such tests for other embodiments of the technique based on the information in table 684.

If there are remaining index expressions for the current pointer that have not yet been selected, the flow proceeds with the most common variable from the remaining expressions (step 615). In the example, there is only one remaining expression (a[m]) that generates the code shown in segment 696 (steps 620, 630, 635, and 640). In the example, all index expressions are then processed and execution continues with the last step (step 655). Additional code is generated to pick the global MIN and MAX values for this pointer among the previously generated local minima and maxima. Such code for exemplary list 682 is shown in segment 698. The whole process is repeated (step 605) for all pointers identified in 315. If there are no remaining pointers, execution continues at step 350 in FIG. 3.

For multi-dimensional arrays, the indices can be converted to linear form and the test applied in the same manner as for single-dimensional arrays. For instance, if an array index a[i][j] is used and the size of the first dimension is 10, the index can be converted to 10i+j which will compute the same address as the original index. Note that the converted index will be used for address calculations but not for indexing. The converted expression can be used in the technique described in this section.

One of skill in the art would be aware that known compiler optimizations may be applied to the generated tests in order to reduce size and/or execution time of said tests.

### E. A Second Technique to Generate Pointer Bounds

The second technique to generate pointer bounds analyzes the program flow preceding the loop to be parallelized, i.e., not only within the current function. It is not necessary to have access to the full source code of the program in order to use this technique—only enough of the source code to cover the memory allocations for pointers used in the loop to be parallelized.

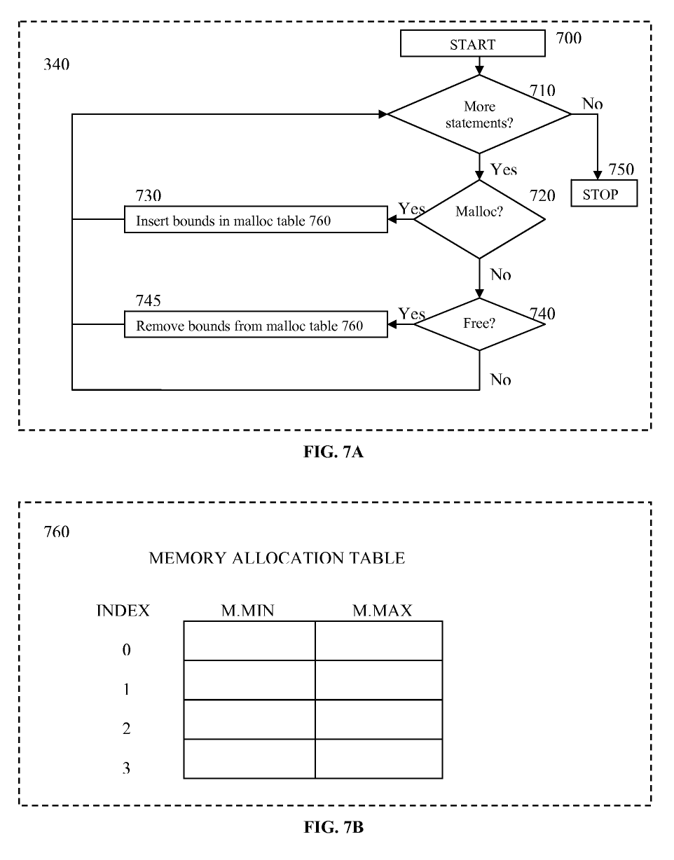

FIG. 7A is a flow chart that illustrates this second technique. FIG. 7B illustrates MEMORY ALLOCATION TABLE 760, which is utilized by this technique. For each code segment, as long as there remain statements to be analyzed (step 710), the next remaining statement is first checked for memory allocations (for instance malloc statements in the C language or new statements in the C++ language). If the statement allocates memory (step 720), a new code segment is inserted in the program after the memory allocation statement (step 730). This code segment adds a new entry to MEMORY ALLOCATION TABLE 760. The M.MIN field of the table holds the starting address (lower bound) of the allocated memory area, and the M.MAX field holds the ending address (upper bound) of the memory area. If the statement does not allocate memory the statement is then checked for memory deallocations (called free statements in both the C and C++ language) (step 740). If the statement deallocates memory, code is inserted to locate and remove an entry with the deallocated memory area from MEMORY ALLOCATION TABLE 760 (step 745).

Code insertions occur when both of the following conditions are met: (1) the second technique is used for a dependency check in code that may follow the allocation/deallocation statement; and (2) a cost/benefit analysis has deemed such a check to be likely beneficial.

The next step of the second technique is to use MEMORY ALLOCATION TABLE 760 in a dependency test. Pointers belonging to different allocation units can not overlap unless they are reassigned. That is, if two pointers are used but not reassigned within the loop to be parallelized (i.e., only pointer arithmetic is used), and they are found to belong to different allocation units just prior to said loop, accesses from the two pointers cannot overlap. The dependency test is therefore constructed as a check that pointers do not point to the same allocation area. For each pointer, the pointer address is compared to the entries in MEMORY ALLOCATION TABLE 760. First, the pointer is compared to M.MIN. If the pointer address>M.MIN for an entry it is compared to M.MAX for the same entry. If the pointer is larger than M.MIN and smaller than M.MAX it is a match; the pointer is said to belong to this memory allocation area.

### F. Generating Dependency Test Code

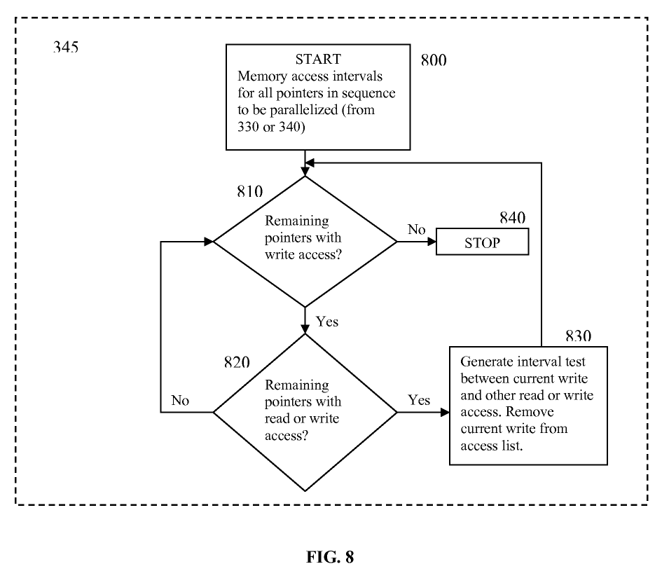

If memory allocation areas are established for all pointers in the loop to be parallelized, the dependency test code can be generated. A flow chart for generation of dependency tests is shown in FIG. 8. This flow chart is a detailed description of step 345 in FIG. 3.

The dependency test generation phase uses the memory access intervals calculated in 330 or 340 (step 800). For each pointer wherein a write is performed to the pointer address (step 810), a check is generated for each of the remaining pointers (“remaining” includes all pointers except the write pointer for which tests have already been generated) (step 820).

The generated dependency test (step 830) for memory intervals, according to the first technique for generating pointer bounds, is a comparison of the minimum and maximum values for each pointer. For instance, for two pointers a and b, if either max[a] and min[a] are both larger than max[b] or both smaller than min[b], then the pointers' access intervals do not overlap, and execution should continue with further tests if any remains, or with the parallelized version of the loop if no more test remains. If there is an overlap, then there is a potential dependency violation, and execution should continue with the sequential version of the loop.

The generated dependency test (step 830) for memory intervals, according to the second technique for generating pointer bounds, involves a comparison of the indices in the MEMORY ALLOCATION TABLE 660 for the areas the pointers belongs to. For instance, if a pointer a is found to belong to the area with index 2, and a pointer b is found to belong to the area with index 3, the pointers a and b do not overlap. The result of the dependency test is used in the same manner as for the first technique described above.

When there are no more write pointer accesses left to process, all tests have been generated (step 810) and the dependency test generation terminates (step 840).

### G. General Details

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard, a pointing device, e.g., a mouse or a trackball, or a musical instrument including musical instrument data interface (MIDI) capabilities, e.g., a musical keyboard, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results. Additionally, the invention can be embodied in a purpose built device.

What is claimed is:

1. A computer-implemented method for performing dynamic pointer disambiguation, comprising:
locating one or more indexing expressions within a code segment to be parallelized;
generating code that establishes at run-time a first memory allocation area for a first pointer in the code segment to be parallelized by calculating a lower bound and an upper bound of the first memory allocation area, wherein the lower and upper bounds of the first memory allocation area are defined by at least one of the one or more indexing expressions;
generating code that establishes at run-time a second memory allocation area for a second pointer in the code segment to be parallelized by calculating a lower bound and an upper bound of the second memory allocation area, wherein the lower and upper bounds of the second memory allocation area are defined by at least one of the one or more indexing expressions; and
generating dependency test code that compares the lower bound and the upper bound of the first memory allocation area against the lower bound and the upper bound of the second memory allocation area to determine whether an overlap exists, wherein the first pointer and the second pointer both appear within the code segment to be parallelized, and wherein at least one of the first pointer and the second pointer has write access.

2. The method of claim 1, wherein no overlap exists, further comprising executing a parallelized version of the code segment.

3. The method of claim 1, wherein an overlap does exist, further comprising executing a sequential version of the code segment.

4. A computer-implemented method for performing dynamic pointer disambiguation, comprising:
analyzing one or more code segments preceding a code segment to be parallelized, wherein a code segment comprises one or more statements;
inserting a test code segment, wherein the test code segment is inserted after a statement, and wherein the test code segment operates to update a memory allocation table, the memory allocation table comprising one or more entries, wherein each of the one or more entries comprises a lower bound and an upper bound for a block of memory;
generating code that establishes at run-time a memory allocation area for a pointer in the code segment to be parallelized, wherein establishing a memory allocation area for a pointer comprises comparing a lower bound and an upper bound of a block of memory that can be accessed by the pointer against the memory allocation table; and
generating dependency test code that compares a first lower bound and a first upper bound of a first memory allocation area for a first pointer against a second lower bound and a second upper bound of a second memory allocation area for a second pointer to determine whether an overlap exists, wherein at least one of either the first pointer or the second pointer has write access.

5. The method of claim 4, wherein analyzing comprises detecting a statement that allocates a block of memory.

6. The method of claim 4, wherein analyzing comprises detecting a statement that deallocates a block of memory.

7. The method of claim 5, wherein the test code segment is inserted after the statement that allocates a block of memory, and wherein the test code segment operates to add an entry to the memory allocation table, wherein the entry corresponds to a lower bound and an upper bound of the block of memory.

8. The method of claim 6, wherein the test code segment is inserted after the statement that deallocates a block of memory, and wherein the inserted test code segment operates to locate and remove an entry in the memory allocation table, wherein the entry corresponds to a lower bound and an upper bound of the block of memory.

9. A computer program product, stored on a tangible computer-readable medium, the product comprising instructions operable to cause a computer system to perform a method comprising:
locating one or more indexing expressions within a code segment to be parallelized;
generating code that establishes at run-time a first memory allocation area for a first pointer in the code segment to be parallelized by calculating a lower bound and an upper bound of the first memory allocation area, wherein the lower and upper bounds of the first memory allocation area are defined by at least one of the one or more indexing expressions;
generating code that establishes at run-time a second memory allocation area for a second pointer in the code segment to be parallelized by calculating a lower bound and an upper bound of the second memory allocation area, wherein the lower and upper bounds of the second memory allocation area are defined by at least one of the one or more indexing expressions; and
generating dependency test code that compares the lower bound and the upper bound of the first memory allocation area against the lower bound and the upper bound of the second memory allocation area to determine whether an overlap exists, wherein the first pointer and the second pointer both appear within the code segment to be parallelized, and wherein at least one of the first pointer and the second pointer has write access.

10. The computer program product of claim 9, wherein no overlap exists, further comprising executing a parallelized version of the code segment.

11. The computer program product of claim 9, wherein an overlap does exist, further comprising executing a sequential version of the code segment.

12. A computer program product, stored on a tangible computer-readable medium, the product comprising instructions operable to cause a computer system to perform a method comprising:
analyzing one or more code segments preceding a code segment to be parallelized, wherein a code segment comprises one or more statements;
inserting a test code segment, wherein the test code segment is inserted after a statement, and wherein the test code segment operates to update a memory allocation table, the memory allocation table comprising one or more entries, wherein each of the one or more entries comprises a lower bound and an upper bound for a block of memory;
generating code that establishes at run-time a memory allocation area for a pointer in the code segment to be parallelized, wherein establishing a memory allocation area for a pointer comprises comparing a lower bound and an upper bound of a block of memory that can be accessed by the pointer against the memory allocation table; and
generating dependency test code that compares a first lower bound and a first upper bound of a first memory allocation area for a first pointer against a second lower bound and a second upper bound of a second memory allocation area for a second pointer to determine whether an overlap exists, wherein at least one of either the first pointer or the second pointer has write access.

13. The computer program product of claim 12, wherein analyzing comprises detecting a statement that allocates a block of memory.

14. The computer program product of claim 12, wherein analyzing comprises detecting a statement that deallocates a block of memory.

15. The computer program product of claim 13, wherein the test code segment is inserted after the statement that allocates a block of memory, and wherein the test code segment operates to add an entry to the memory allocation table, wherein the entry corresponds to a lower bound and an upper bound of the block of memory.

16. The computer program product of claim 14, wherein the test code segment is inserted after the statement that deallocates a block of memory, and wherein the inserted test code segment operates to locate and remove an entry in the memory allocation table, wherein the entry corresponds to a lower bound and an upper bound of the block of memory.

17. A system, comprising:
a machine-readable storage device including a computer program product;
a display device; and
one or more processors capable of interacting with the display device and the machine-readable storage device, and operable to execute the computer program product to perform operations comprising:
locating one or more indexing expressions within a code segment to be parallelized;
generating code that establishes at run-time a first memory allocation area for a first pointer in the code segment to be parallelized by calculating a lower bound and an upper bound of the first memory allocation area, wherein the lower and upper bounds of the first memory allocation area are defined by at least one of the one or more indexing expressions;
generating code that establishes at run-time a second memory allocation area for a second pointer in the code segment to be parallelized by calculating a lower bound and an upper bound of the second memory allocation area, wherein the lower and upper bounds of the second memory allocation area are defined by at least one of the one or more indexing expressions; and
generating dependency test code that compares the lower bound and the upper bound of the first memory allocation area against the lower bound and the upper bound of the second memory allocation area to determine whether an overlap exists, wherein the first pointer and the second pointer both appear within the code segment to be parallelized, and wherein at least one of the first pointer and the second pointer has write access.

18. The system of claim 17, wherein no overlap exists, further comprising executing a parallelized version of the code segment.

19. The system of claim 17, wherein an overlap does exist, further comprising executing a sequential version of the code segment.

20. A system, comprising:
a machine-readable storage device including a computer program product;
a display device; and
one or more processors capable of interacting with the display device and the machine-readable storage device, and operable to execute the computer program product to perform operations comprising:
analyzing one or more code segments preceding a code segment to be parallelized, wherein a code segment comprises one or more statements;
inserting a test code segment, wherein the test code segment is inserted after a statement, and wherein the test code segment operates to update a memory allocation table, the memory allocation table comprising one or more entries, wherein each of the one or more entries comprises a lower bound and an upper bound for a block of memory;
generating code that establishes at run-time a memory allocation area for a pointer in the code segment to be parallelized, wherein establishing a memory allocation area for a pointer comprises comparing a lower bound and an upper bound of a block of memory that can be accessed by the pointer against the memory allocation table; and
generating dependency test code that compares a first lower bound and a first upper bound of a first memory allocation area for a first pointer against a second lower bound and a second upper bound of a second memory allocation area for a second pointer to determine whether an overlap exists, wherein at least one of either the first pointer or the second pointer has write access.

21. The system of claim 20, wherein analyzing comprises detecting a statement that allocates a block of memory.

22. The system of claim 20, wherein analyzing comprises detecting a statement that deallocates a block of memory.

23. The system of claim 21, wherein the test code segment is inserted after the statement that allocates a block of memory, and wherein the test code segment operates to add an entry to the memory allocation table, wherein the entry corresponds to a lower bound and an upper bound of the block of memory.

24. The system of claim 22, wherein the test code segment is inserted after the statement that deallocates a block of memory, and wherein the inserted test code segment operates to locate and remove an entry in the memory allocation table, wherein the entry corresponds to a lower bound and an upper bound of the block of memory.
